(19) United States
(12) Patent Application Publication
(10) Pub. No.: US 2024/0239675 A1
(43) Pub. Date: Jul. 18, 2024

(54) A METHOD FOR PRODUCING LITHIUM HYDROXIDE FROM LITHIUM-CONTAINING RAW MATERIAL

(71) Applicants: RESEARCH INSTITUTE OF INDUSTRIAL SCIENCE & SCIENCE & TECHNOLOGY, Pohang-si Gyeongsangbuk-do (KR); POSCO CO., LTD., Pohang-si Gyeongsangbuk-do (KR)

(72) Inventors: Woo Chul JUNG, Pohang-si (KR); Gi-Chun HAN, Cheongju-si (KR); Young-Seon KO, Pohang-si, Gyeongsangbuk-do (KR); Seung Goo KIM, Seoul (KR); Kiyoung KIM, Pohang-si (KR); Woonkyoung PARK, Pohang-si (KR); Kyunghoon KIM, Pohang-si (KR); Juyoung KIM, Pohang-si (KR); Hyun Woo LEE, Pohang-si (KR)

(73) Assignees: RESEARCH INSTITUTE OF INDUSTRIAL SCIENCE & SCIENCE & TECHNOLOGY, Pohang-si Gyeongsangbuk-do (KR); POSCO CO., LTD., Pohang-si Gyeongsangbuk-do (KR)

(21) Appl. No.: 18/023,553

(22) PCT Filed: Aug. 24, 2021
(86) PCT No.: PCT/KR2021/011322

§ 371 Date: Aug. 25, 2023

(30) Foreign Application Priority Data
Aug. 25, 2020 (KR) 10-2020-0107133

(51) Int. Cl. C01D 15/02

(52) U.S. Cl. CPC C01D 15/02

(57) ABSTRACT

The present disclosure relates to a lithium hydroxide manufacturing method, which includes: roasting a lithium-containing raw material in sulfuric acid; leaching the roasted lithium-containing raw material to obtain a solution containing lithium sulfate; a first purifying the leaching solution with a pH of 7.1 to 9.5; a second purifying the first purified solution with pH of 9 to 11; and obtaining an aqueous solution of a lithium hydroxide by bipolar electrodialysis of the second purified a solution.

### FIELD OF THE INVENTION

One embodiment of the present invention may provide a method for producing lithium hydroxide from lithium-containing raw material. Specifically, one embodiment of the present invention may provide a method for preparing lithium hydroxide from lithium-containing raw material by electrodialysis.

### DESCRIPTION OF THE RELATED ART

The conventional art of manufacturing lithium hydroxide can be classified into a lithium leaching process and a process for obtaining lithium hydroxide.

First, the process of leaching lithium from ore changes the crystal structure into a good crystal structure for extracting lithium through calcination. This is to change the form for extracting lithium in the ore through acid-roasting. Next, an acidic solution containing lithium is obtained through leaching.

The acid used for acid-roasting process mainly uses sulfuric acid (H₂SO₄), and some processes use hydrochloric acid (HCl), but due to environmental problems, sulfuric acid is used in almost all currently commercially available processes. The resultantly the acidic solution containing lithium is obtained in the state of an aqueous solution of lithium sulfate (Li₂SO₄), which is a known technology used in most processes of extracting lithium from ore.

Among the aqueous solution of lithium sulfate, obtained after the extraction process, various impurities (Mg, Ca, Fe, Ni, Mn, Si, Al, etc.) derived from the ore are included, which are purified to be used in the subsequent process. Then, it is converted into lithium hydroxide through base treatment.

Second, a method using electrolysis or electrodialysis, which is another process for obtaining lithium hydroxide from lithium sulfate, is known. A process for producing a solution of lithium hydroxide by directly injecting a solution of lithium sulfate into an electrolysis or electrodialysis device is known. Alternatively, a method is known in which phosphoric acid (H₃PO₄) is added to obtain the form of lithium phosphate (Li₃PO₄), and then changed to lithium sulfate form and then injected into an electrolysis and electrodialysis device to obtain an aqueous solution of lithium hydroxide.

This conventional art has a low yield of high-purity lithium hydroxide hydrate (LiOH·H₂O) that can be used as a battery material. It has issues such as the management and loss of electrolysis electrodes during the process, the stability of the dialysis membrane caused by the use of phosphoric acid, and the problem of environmental.

### SUMMARY OF THE INVENTION

The present invention is to effectively extract lithium from a raw material containing lithium by reducing the use of Na-based subsidiary materials and minimizing the generation of wastewater containing sodium hydroxide generated during the manufacturing process. Accordingly, it can be provided that economically and environmentally advantageous lithium hydroxide is manufactured.

The lithium hydroxide manufacturing method of one embodiment includes:
roasting a lithium-containing raw material in sulfuric acid; leaching the roasted lithium-containing raw material to obtain a solution containing lithium sulfate; a first purifying the leaching solution with a pH of 7.1 to 9.5; a second purifying the first purified solution with pH of 9 to 11; and obtaining an aqueous solution of a lithium hydroxide by bipolar electrodialysis of the second purified a solution.

The lithium-containing raw material comprises a lithium-containing ore

The method further comprises calcinating the lithium-containing raw material at 950 to 1100° C. before roasting.

The roasting the lithium-containing raw material is to use concentrated sulfuric acid with a concentration of 95% or more.

In the roasting the lithium-containing raw material in sulfuric acid, a sulfuric acid equivalent is at a weight ratio of 200 to 300% to lithium weight, roasting temperature is 180 to 300° C., and roasting time is 40 to 120 minutes.

The leaching the roasted lithium-containing raw material to obtain a solution containing lithium sulfate is performed by using water or diluted sulfuric acid.

The water is purified water, the dilute sulfuric acid is recycled from the step of obtaining an aqueous solution of a lithium hydroxide by bipolar electrodialysis of the second purified a solution.

As the first purification step to purify the leaching a solution, the first purifying the leaching solution with a pH of 7.1 to 9.5 is performed by adjusting the pH using a source of non-Na-based alkali.

The source of non-Na-based alkali comprises calcium hydroxide (Ca(OH)₂).

The leaching step and the first purification step are conducted in a single reactor.

As the second purification step to purify the a second purifying the first purified solution with pH of 9 to 11 is performed by adjusting pH using a source of an alkali metal carbonate.

An additional purification step using an ion-exchange resin is included to remove trace impurities remaining after the second purification step.

In the step of obtaining an aqueous solution of a lithium hydroxide by bipolar electrodialysis of the second purified a solution, it is further comprised a step of supplying a generated diluted sulfuric acid to the leaching step reactor.

After a step of obtaining an aqueous solution of a lithium hydroxide by bipolar electrodialysis of the second purified a solution, a step of crystallizing the obtained aqueous solution of a lithium hydroxide is further included.

The step of crystallizing the obtained aqueous solution of a lithium hydroxide comprises:
obtaining lithium hydroxide hydrate through primary crystallization; re-dissolving the obtained lithium hydroxide hydrate; obtaining a final lithium hydroxide hydrate through secondary crystallization of the re-dissolved solution.

According to one embodiment of the present invention, impurities can be effectively removed to obtain high-purity lithium hydroxide.

According to another embodiment of the present invention, the amount of sodium hydroxide generated during the manufacturing process can be reduced by not using Na-based additives. Therefore, it is possible to provide a manufacturing method for lithium hydroxide, that is environmentally-friendly and the process conditions are not harsh.

### BRIEF DESCRIPTION OF THE DRAWINGS

FIG. 1 is a flowchart of the lithium hydroxide manufacturing process of one embodiment of the present disclosure.

FIG. 2 is a flowchart of the lithium hydroxide manufacturing process of another embodiment of the present disclosure.

FIG. 3 shows the pH change over time in the case of using sodium hydroxide (NaOH) and calcium hydroxide (Ca(OH)₂) for pH control in the first purification step.

FIG. 4 shows the behavior of Ca, Mg, and Mn impurities according to pH fluctuations.

FIG. 5 shows the behavior of Al and Si impurities according to pH fluctuations.

### DETAILED DESCRIPTION OF THE EMBODIMENTS

Terms such as first, second and third are used to describe various parts, components, regions, layers and/or sections, but are not limited thereto. These terms are only used to distinguish one part, component, region, layer or section from another part, component, region, layer or section. Therefore, a first part, component, region, layer or section described below may be referred to as a second part, component, region, layer or section within the scope of the present invention.

The terminology used herein is merely to refer to a specific Example and is not intended to limit the present invention. As used herein, the singular forms also include the plural forms unless the phrases clearly indicate the opposite. As used in the specification, the meaning of “comprising” specifies a particular characteristic, domain, integer, step, action, component and/or composition, and it does not exclude the presence/absence or addition of another characteristic, domain, integer, step, action, component and/or composition.

When a part is referred to as being “on” or “above” another part, it may be directly on top of or above the other part, or may be followed by another part in between. In contrast, when a part is said to be “directly on” another part, there is no intervening part between them.

In addition, unless otherwise noted, % means wt %, and 1 ppm is 0.0001 wt %.

Although not defined differently, all terms including technical terms and scientific terms used herein have the same meaning as commonly understood by a person of an ordinary skill in the technical field to which the present invention belongs. Terms defined in commonly used dictionaries are additionally interpreted as having meanings consistent with related technical literature and currently disclosed content, and are not interpreted in ideal or very formal meanings unless defined.

Hereinafter, an exemplary embodiment of the present invention will be described in detail so that a person of an ordinary skill can easily practice it in the technical field to which the present invention belongs. As those skilled in the art would realize, the described embodiments may be modified in various different ways, all without departing from the spirit or scope of the present invention.

Hereinafter, each step is examined in detail.

The present disclosure intends to provide a method for producing lithium hydroxide using an ore containing lithium, specifically, spodumene concentrate.

First, the ore raw material containing lithium is calcinated to change the crystal phase of the ore from α-phase spodumene in the initial state to ß-phase spodumene that is easy to roast and leach. At this time, the temperature of calcination may range from 950 to 1100° C. In case of calcination at a temperature lower than the temperature, uncalcinated parts may occur. Or, when calcination occurs at a higher the temperature, the efficiency of leaching lithium is deteriorated due to excessive calcination.

Acid roasting is performed on the ore after the calcination is completed. At this time, the acid roasting process may use 95% or more concentrated sulfuric acid (or anhydrous sulfuric acid). The equivalent of sulfuric acid to be injected may be 200-300% in weight ratio with respect to the weight of lithium contained in the ore. The roasting temperature is 180-300° C., and the roasting time may be 40 to 120 minutes.

Them, the roasted ore is leached. The solvent used at this time can be purified water or diluted sulfuric acid that does not contain impurities. The purified water may be fresh water treated with RO or the like. The diluted sulfuric acid may be recycled diluted sulfuric acid (6-10% H₂SO₄) from bipolar electrodialysis to reduce process cost and utilize by-products.

An aqueous solution that has the leaching process as described above is obtained as a solution containing lithium sulfate (Li₂SO₄) as a main component. In a solution, various impurities (Al, Si, Ca, Mg, Fe, Ni, Na, K, etc.) caused by the ore raw material are present, and the purification step described later is performed.

For the purification of the solution of lithium sulafate, a two-step chemical purification process can be performed. The first purification step uses a non-Na-based alkali a source, and the pH of the first purification step may be 7.1 to 9.5. That is, the first purification step may be performed in a pH range exceeding the range of 5-7, which is the pH range in which Al and Si impurities are precipitated and purified.

In addition, the first purification step of the present disclosure can use calcium hydroxide (Ca(OH)₂) as a non-Na-based alkali a source. This process is stable in pH fluctuation compared to the process using NaOH as an alkali source. In the case of NaOH, the initial pH rises rapidly due to the rapid reaction and then decreases again, so it is difficult to control the pH during the process (pH 4-9 fluctuations). In contrast, in the case of using a non-Na-based alkali source, that is, calcium hydroxide, the pH immediately increases to 8 or more after addition, and the pH of a solution maintains 7.1 or more even 2 hours after addition. That is, the pH does not lower below 7.1, which is the pH range of the primary purification process used in the developed process, and the reaction time of the disclosed process is within 1 hour.

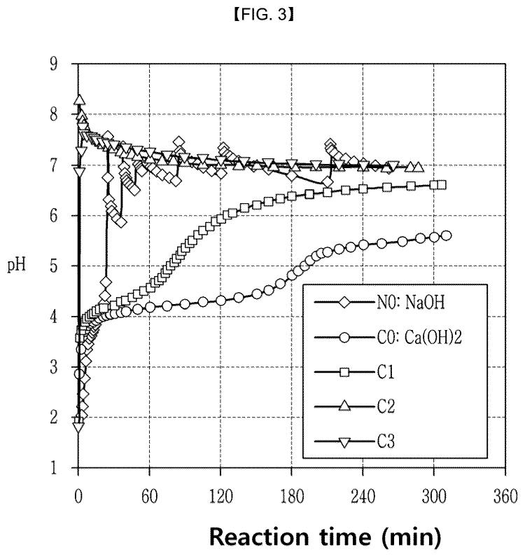

At this time, since calcium hydroxide has low solubility, it can be supplied in a slurry state for effective supply. The solid-liquid ratio of calcium hydroxide slurry is 5:1 in the weight ratio of ‘water:calcium hydroxide’, and the input variation of ±20% is allowed for the 5:1 condition. That is, the ratio of solid-liquid may be 4:1 to 6:1. The mol ratio of OH⁻ according to the variation of the mixing ratio of the slurry can also allow ±20% input variation for the target amount of 0.13 mol. That is, the molar ratio of OH⁻ may be 0.104 to 0.156 (referring to FIG. 3).

TABLE 1

| | | | | | | | | pH | | |
|---|---|---|---|---|---|---|---|---|---|---|
| | Calcinated | distilled | supplementary material | | | | agitate | At the | After | |
| | ore | water | | Purity | input | [OH]⁻ | speed | input | input | |
| Division | (g) | (g) | Compound | (%) | (g) | (mol) | (rpm) | before | 1 h | 2 h |
| 1 | 100 | 200 | NaOH (aq) | 25 | 20.6 | 0.13 | 150 | 1.9 | 7.0 | 6.8 |
| 2 | 100 | 155 | Ca(OH)₂ (aq) | 9.5 | 50 | 0.13 | 150 | 1.8 | 7.3 | 7.1 |

The theoretical maximum precipitation pH range for Al material, which is usually pure Aluminum, is in the range of 5 to 7. However, in the case of an aqueous solution of lithium sulfate, obtained by the leaching, various impurity ions exist inside the solution. Due to this, the common ion effect and interaction with oxides suspended particles, may act. Accordingly, the Al precipitation pH range in an aqueous solution of lithium sulfate, may be a pH range of 7.1 to 9.5 slightly above the theoretical precipitation pH range. The first purification step disclosed in the present invention is characterized by using the pH range. Specifically, the first purification step pH may be 7.2 to 9.5, more specifically 7.6 to 9.5, more specifically 7.9 to 9.5, more specifically 7.1 to 7.9, more specifically 7.2 to 7.9, and more specifically 7.6 to 7.9.

In addition, the above leaching and first purification steps are described as two separate processes. However, in a practical process, the leaching and first purification steps can be done in a single reactor. In other words, leaching and first purification steps can be performed simultaneously by putting roasted ore into one reactor, then charging leaching solution, and then reacting with a slurry of non-Na-based alkali source. The leaching solution may be purified water or dilute sulfuric acid as described above.

Subsequently, a second sperm step is performed. The second purification step may be a step to remove, a trace amount of impurities not removed in the first purification step and/or a residual metal (e.g., Ca) component resulting from the added non-Na-based alkali source (e.g., calcium hydroxide). In the second purification step, the pH is raised to the range of 9 to 11 using an alkali metal carbonate salt to remove trace impurities in the form of carbonate. Specifically, an alkali metal carbonate salt may be Na₂CO₃.

Next, if trace amounts of Ca and Mg remain in the aqueous solution of lithium sulfate that has gone through the second purification step, an additional purification step can be performed using an ion-exchange resin. The criterion for passing through the additional purification step is when the concentration of Ca and Mg in an aqueous solution of lithium sulfate exceeds 10 ppm, respectively, after the second purification step. If it is less than this, it is not subjected to an additional purification step.

In order to convert the purified an aqueous solution of lithium sulfate obtained through the first and second purification steps (additional purification steps if necessary) to lithium hydroxide (LiOH), a bipolar electrodialysis step is performed. The bipolar electrodialysis step is a step that converts an aqueous solution of lithium sulfate introduced into the bipolar electrodialysis apparatus into an aqueous solution of lithium hydroxide and a solution of sulfuric acid.

The concentration of lithium hydroxide produced in the bipolar electrodialysis step is characterized by 2-3 mol, and the concentration of sulfuric acid obtained can be adjusted to the level of 5-10%. In addition, some of the generated desalted water can be recycled to the process of obtaining lithium carbonate through dilution of a purge solution in the primary crystallizer. In addition, the obtained diluted sulfuric acid can be recycled as leaching solution in the leaching process.

The bipolar electrodialysis apparatus used in present disclosure may have a structure in which a positive electrode cell including a positive electrode, a first bipolar membrane, a negative ion selective dialysis membrane, a positive ion selective dialysis membrane, a second bipolar membrane, and a negative electrode cell including a negative electrode are sequentially disposed. When treated with such a bipolar electrodialysis apparatus, SO₄²⁻ moving through the negative ion-selective dialysis membrane meets hydrogen hydrolyzed in the bipolar membrane on the positive electrode side to obtain sulfuric acid. The lithium ion moving to the negative electrode through the positive ion selective dialysis membrane reacts with the hydroxide negative ion generated in the bipolar membrane to obtain LiOH.

In the present disclosure, the purified aqueous solution of lithium sulfate obtained through the first and second purification steps (additional purification steps if necessary) can be applied with a voltage in the range of 1.8 to 2.2V to the bipolar electrodialysis apparatus. In this case, positive ions and negative ions in the aqueous solution of lithium sulfate react to produce LiOH as in an electrophoresis effect described above.

In the step of converting to LiOH using the bipolar electrodialysis apparatus, the bipolar electrodialysis apparatus is equipped with several sets of first bipolar membrane, negative ion selective dialysis membrane, positive ion selective dialysis membrane and second bipolar membrane as one set. In addition, the voltage applied per set may range from 1.8 to 2.2V. Also, the applied current density may be 30 mA/cm² to 90 mA/cm². If the current density is lower than 30 mA/cm², there may be a drawback that the production speed is reduced because the moving speed of lithium is slow. When the current density is exceeding 90 mA/cm², it may cause damage to the bipolar electrodialysis membrane due to heat generation.

The present disclosure of method for lithium hydroxide may further include a crystallization step to convert to solid-phase and purify the aqueous solution of lithium hydroxide obtained through the bipolar electrodialysis step. The crystallization step may include a step of obtaining lithium hydroxide hydrate through first crystallization, a step of dissolving it again, and a step of obtaining final lithium hydroxide hydrate through secondary crystallization.

In the crystallization step, as a means for removing Na and K ions, which are monovalent ion impurities, contained in lithium ore, the amount of a purge solution of the crystallizer in the first crystallization step can be set to 17 to 18% based on the incoming lithium concentration. At this time, in order to recover lithium in the purge solution, lithium in the purge solution may be fixed with lithium carbonate. At this time, the purge solution generated in the crystallizer is a saturated a solution of lithium hydroxide. De-salted water generated from bipolar electrodialysis can be used to dilute that to an appropriate range of concentration, <30 g/L based on lithium concentration. Since the diluted purge solution is in an alkali state, it can be prepared with lithium carbonate using carbonate gas CO₂. The manufactured lithium carbonate is washed to obtain purified lithium carbonate, and Na and K ions, which are monovalent ion impurities derived from ores, can be discharged through washing water.

The diluted sulfuric acid (6-10%) generated in the bipolar electrodialysis step of one embodiment of present disclosure is in a state in which sulfate (SO₄²⁻) is included in purified water.

Accordingly, the method for recycling in the process thereof is as follows.

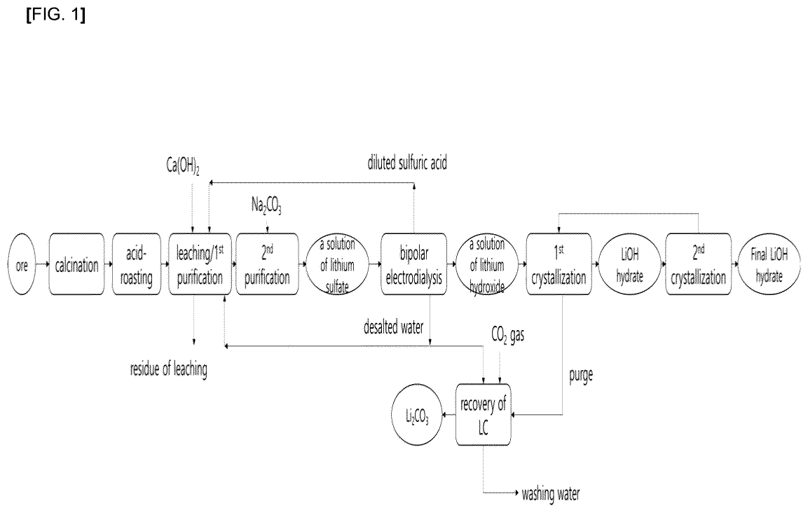

First, the diluted sulfuric acid generated in the bipolar electrodialysis step is supplied to the reactor where the leaching and first purification steps are performed. Sulfate other than water is changed into CaSO₄·2H₂O by a non-Na based alkali (e.g., calcium hydroxide) injected into the leaching/first purification step reactor. It can be treated and discharged with the resulting ore residue (see FIG. 1).

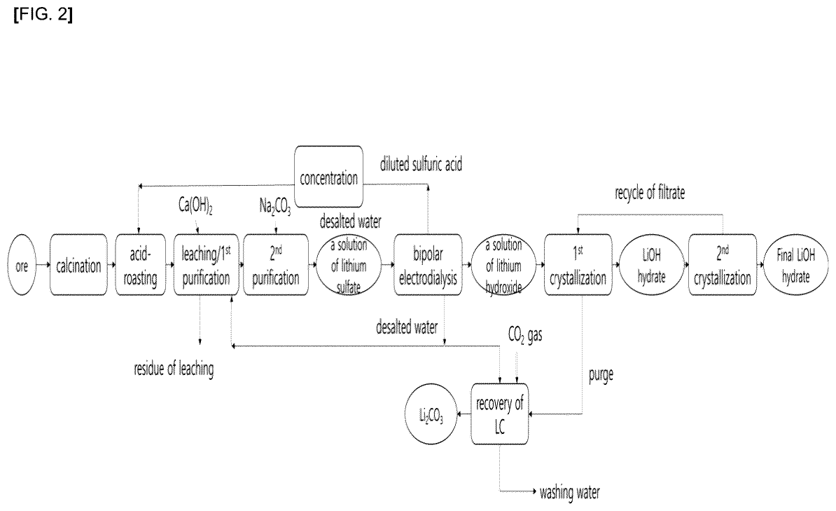

Also, in the case of concentrating the diluted sulfuric acid in the process, sulfuric acid may be concentrated at 93%-97%. Concentrated sulfuric acid can also replace the sulfuric acid used in the roasting process. The water obtained at this time can be used as leaching solution used in process as whole amount (see FIG. 2).

Hereinafter, an exemplary embodiment of the present invention will be described in detail so that a person of an ordinary skill can easily practice it in the technical field to which the present invention belongs. However, the present invention can be implemented in many different forms, and is not limited to the example described above.

### EXAMPLE

Lithium hydroxide was produced using spodumene concentrate of lithium-containing ore. The manufacturing method was carried out according to the disclosed method.

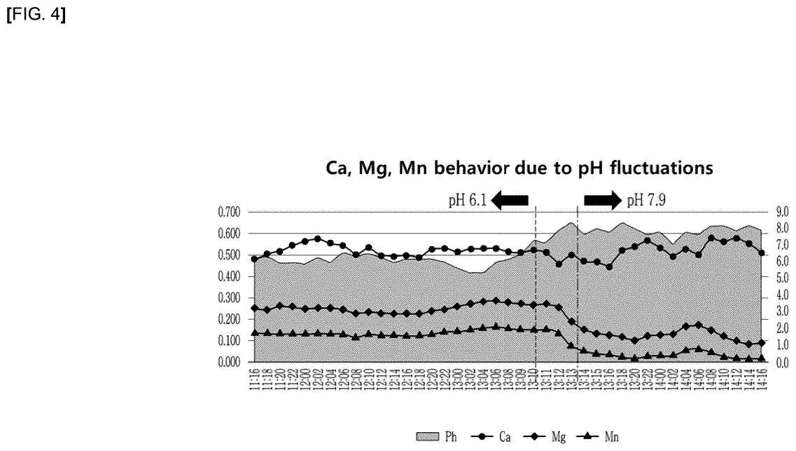

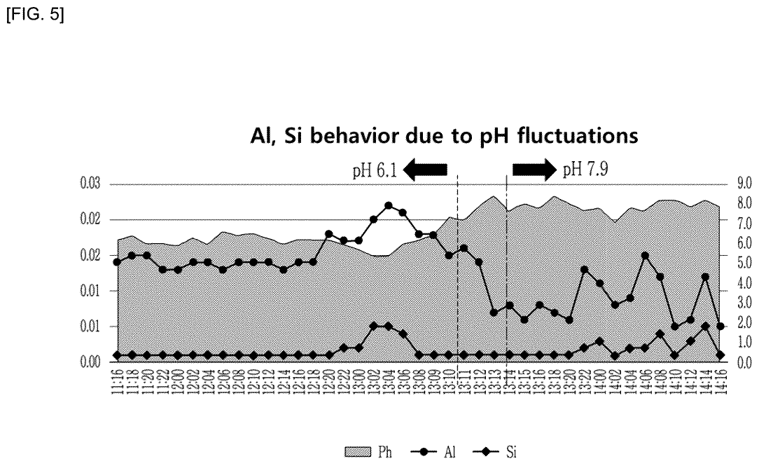

In the first purification step, the pH was adjusted to 7.1 to 9.5 using calcium hydroxide (Ca(OH)₂) as an example. In Comparative Example, lithium hydroxide was prepared by the same method as the example, except that the pH was controlled using NaOH in the first purification step. The results tested through actual process equipment are shown in Table 2. Impurity behaviors of the example and Comparative example were compared and disclosed in FIGS. 4 and 5.

Example, which was operated at pH 7.1 to 8.4, showed lower concentrations of Mg, Mn, and Si than Comparative Example, confirming that purification was better. Mg and Mn leached better with increasing pH. On the other hand, since Ca(OH)₂ remains are depending on the solubility level of Ca regardless of the amount of Ca(OH)₂ used, a result with no change in Ca was obtained.

Also, in Example, Si was further leached by co-precipitation as the leaching amount of divalent positive ions such as Mg and Mn increased. In the case of Al, even when the pH exceeded 8, the result was slightly increased. In the case of manufacturing lithium hydroxide using the pH range of the first purification step of Example, it was confirmed that there is no problem in manufacturing process management and battery-grade lithium hydroxide hydrate.

TABLE 2

| Division | Ph | Li | Na | Ca | K | Al | S | Mg | Sr | Fe | Ni | Si | Mn |
|---|---|---|---|---|---|---|---|---|---|---|---|---|---|
| Normal pH | 6.1 | 17.80 | 1.32 | 0.5223 | 0.2170 | 0.0016 | 46.32 | 0.2514 | 0.0020 | 0.0005 | 0.0001 | 0.0157 | 0.1376 |
| improved | 7.1 | 17.76 | 1.45 | 0.4841 | 0.1921 | 0.0010 | 43.87 | 0.1294 | 0.0020 | 0.0010 | 0.0000 | 0.0078 | 0.0304 |
| pH | 7.2 | 17.60 | 1.33 | 0.5130 | 0.2250 | 0.0010 | 44.86 | 0.2720 | 0.0020 | 0.0010 | 0.0000 | 0.0160 | 0.1530 |
| | 7.6 | 17.80 | 1.37 | 0.5220 | 0.2070 | 0.0000 | 43.37 | 0.0770 | 0.0020 | 0.0000 | 0.0000 | 0.0060 | 0.0140 |
| | 7.9 | 17.03 | 1.37 | 0.5167 | 0.1964 | 0.0017 | 42.60 | 0.1181 | 0.0020 | 0.0003 | 0.0000 | 0.0080 | 0.0302 |

The present invention is not limited to the exemplary embodiment, but can be manufactured in a variety of different forms, and a person of an ordinary skill in the technical field to which the present invention belongs is different without changing the technical idea or essential features of the present invention. It will be appreciated that it may be embodied in specific forms. Therefore, the exemplary embodiment described above should be understood as illustrative in all respects and not limiting.

What is claimed is:

1. A method of preparing a lithium hydroxide comprising:
roasting a lithium-containing raw material in sulfuric acid;
leaching the roasted lithium-containing raw material to obtain a solution containing lithium sulfate;
a first purifying the leaching solution with a pH of 7.1 to 9.5;
a second purifying the first purified solution with pH of 9 to 11; and
obtaining an aqueous solution of a lithium hydroxide by bipolar electrodialysis of the second purified a solution.

2. The method of claim 1, wherein:
the lithium-containing raw material comprises a lithium-containing ore.

3. The method of claim 1, wherein:
the method further comprises calcinating the lithium-containing raw material at 950 to 1100° ° C. before roasting.

4. The method of claim 1, wherein:
the roasting the lithium-containing raw material is to use concentrated sulfuric acid with a concentration of 95% or more.

5. The method of claim 1, wherein:
in the roasting the lithium-containing raw material in sulfuric acid, a sulfuric acid equivalent is at a weight ratio of 200 to 300% to lithium weight, roasting temperature is 180 to 300° C., and roasting time is 40 to 120 minutes.

6. The method of claim 1, wherein:
the leaching the roasted lithium-containing raw material to obtain a solution containing lithium sulfate is performed by using water or diluted sulfuric acid.

7. The method of claim 6, wherein:
the water is purified water, the dilute sulfuric acid is recycled from the step of obtaining an aqueous solution of a lithium hydroxide by bipolar electrodialysis of the second purified a solution.

8. The method of claim 1, wherein:
as the first purification step to purify the leaching a solution, the first purifying the leaching solution with a pH of 7.1 to 9.5 is performed by adjusting the pH using a source of non-Na-based alkali.

9. The method of claim 8, wherein:
the source of non-Na-based alkali comprises calcium hydroxide (Ca(OH)₂).

10. The method of claim 1, wherein:
the leaching step and the first purification step are conducted in a single reactor.

11. The method of claim 1, wherein:
as the second purification step to purify the a second purifying the first purified solution with pH of 9 to 11 is performed by adjusting pH using a source of an alkali metal carbonate.

12. The method of claim 1, wherein:
an additional purification step using an ion-exchange resin is included to remove trace impurities remaining after the second purification step.

13. The method of claim 1, wherein:
in the step of obtaining an aqueous solution of a lithium hydroxide by bipolar electrodialysis of the second purified a solution, it is further comprised a step of supplying a generated diluted sulfuric acid to the leaching step reactor.

14. The method of claim 1, wherein:
after a step of obtaining an aqueous solution of a lithium hydroxide by bipolar electrodialysis of the second purified a solution, a step of crystallizing the obtained aqueous solution of a lithium hydroxide is further included.

15. The method of claim 14, wherein:
the step of crystallizing the obtained aqueous solution of a lithium hydroxide comprises:
obtaining lithium hydroxide hydrate through primary crystallization;
re-dissolving the obtained lithium hydroxide hydrate;
obtaining a final lithium hydroxide hydrate through secondary crystallization of the re-dissolved solution.
